(19) United States
(12) Patent Application Publication
(10) Pub. No.: US 2025/0075906 A1
(43) Pub. Date: Mar. 6, 2025

(54) PREMIXING DEVICE AND COMBUSTION DEVICE INCLUDING THE SAME

(71) Applicant: NORITZ CORPORATION, HYOGO (JP)

(72) Inventors: Naoya YOSHIDA, HYOGO (JP); Kyohei OGAWA, HYOGO (JP); Tsuneo FUNABIKI, HYOGO (JP); Shigeo SUGIE, HYOGO (JP)

(73) Assignee: NORITZ CORPORATION, HYOGO (JP)

(21) Appl. No.: 18/812,976

(22) Filed: Aug. 22, 2024

(30) Foreign Application Priority Data
Aug. 30, 2023 (JP) 2023-140254

(51) Int. Cl. F23D 14/62; B01F 23/10; B01F 25/10; B01F 25/421; B01F 25/432; B01F 101/00; F23D 14/04; F24H 1/14

(52) U.S. Cl. CPC F23D 14/62; B01F 23/191; B01F 25/103; B01F 25/4231; B01F 25/432; F23D 14/04; F24H 1/145; B01F 2101/501; F23D 2900/14021

(57) ABSTRACT

A premixing device includes: a blade, arranged midway of a gas flow path through which air flows, and provided with a fuel gas outlet in a region near one end downstream in an air flow direction; a pair of divided flow paths, configured by dividing a portion of the gas flow path by the blade; and a baffle, located upstream of the fuel gas outlet in the air flow direction on an inner peripheral surface of each divided flow path, and being in the shape of a protruding piece or step part protruding inward of each divided flow path. The baffle is provided in at least a portion of an inner region of each divided flow path, and makes it possible to increase a flow velocity of air flowing through an outer region to be higher than a flow velocity of air passing through the inner region.

### CROSS-REFERENCE TO RELATED APPLICATIONS

This application claims the priority benefit of Japan Application No. 2023-140254, filed on Aug. 30, 2023. The entirety of the above-described patent application is hereby incorporated by reference herein and made a part of the present specification.

### BACKGROUND

### Technical Field

The disclosure relates to a premixing device and a combustion device including the same.

Herein, “premixing” refers to processing for mixing air with a fuel gas in advance and generating a combustible mixed gas for the purpose of performing premixing combustion.

### Related Art

An example of a premixing device is as illustrated in FIG. 11. FIG. 11 illustrates a configuration corresponding to (c) of FIG. 6 of Japanese Patent Laid-open No. 2022-99650.

In a premixing device Ae illustrated in FIG. 11, a blade 41a is provided in a gas flow path 3a through which air supplied from the outside flows. The blade 41a extends in a direction orthogonal to the paper surface of FIG. 11. In a place where the blade 41a is provided, the gas flow path 3a is divided into a pair of divided flow paths 30a with the blade 41a interposed therebetween. A fuel gas outlet 80a is provided in a region near one end of the blade 41a downstream in an air flow direction.

According to such a configuration, by utilizing a negative pressure generated due to effects of a flow of the air in the gas flow path 3a, it is possible to cause a fuel gas to flow out from the fuel gas outlet 80a to the gas flow path, and generate a mixed gas of the fuel gas and the air.

However, the aforementioned premixing device Ae has room for improvement, as described below.

That is, the air that has flowed into the gas flow path 3a branches and flows into the pair of divided flow paths 30a, and then joins together at a position in the vicinity facing the fuel gas outlet 80a in a downstream region in the air flow direction of the blade 41a. According to such an air flow (the joining), a negative pressure is less likely to be generated in the position in the vicinity facing the fuel gas outlet 80a, an appropriate amount of fuel gas cannot be caused to flow out from the fuel gas outlet 80a into the gas flow path 3a, and the amount of fuel gas flowing out may be insufficient. In this case, the generated mixed gas has an inappropriate fuel lean mixture ratio, which is not favorable in terms of increasing a turndown ratio. Such a problem becomes pronounced in the case where a total air flow rate through the gas flow path 3a is small and the air has a low flow velocity, making it difficult to generate a strong negative pressure.

One possible method for solving the above problem is to reduce the opening area (flow path area) of the pair of divided flow paths 30a and increase the flow velocity of the air. However, simply adopting such a method may result in an increase in flow path resistance of each divided flow path 30a, causing an increase in pressure loss.

### SUMMARY

A premixing device provided according to a first aspect of the disclosure includes: a gas flow path forming member, having a gas flow path formed therein through which air supplied from outside flows; a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air; and a pair of divided flow paths, configured by dividing a portion of the gas flow path by the blade, and arranged side by side on both sides of the blade with the blade interposed therebetween in an x direction intersecting the air flow direction. The premixing device further includes: a baffle, located upstream of the fuel gas outlet in the air flow direction on an inner peripheral surface of each of the divided flow paths, and being in the shape of a protruding piece or step part protruding inward of each of the divided flow paths. The baffle is provided in at least a portion of an inner region on the blade side of each of the divided flow paths, and is configured to increase a flow velocity of air flowing through an outer region opposite the inner region to be higher than a flow velocity of air passing through the inner region.

A premixing device provided according to a second aspect of the disclosure includes: a gas flow path forming member, having a gas flow path formed therein through which air supplied from outside flows; a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air; and a pair of divided flow paths, configured by dividing a portion of the gas flow path by the blade, and arranged side by side on both sides of the blade with the blade interposed therebetween in an x direction intersecting the air flow direction. As the fuel gas outlet, a pair of fuel gas outlets are provided to open on both side surfaces of the region near the one end of the blade and respectively facing downstream regions of the pair of divided flow paths in the air flow direction.

### BRIEF DESCRIPTION OF THE DRAWINGS

FIG. 1 is a schematic explanatory diagram illustrating an example of a combustion device including a premixing device according to the disclosure.

FIG. 2 is a perspective view of an appearance of the premixing device of FIG. 1.

FIG. 3 is an exploded perspective view of FIG. 2.

FIG. 4A is a front cross-sectional view (corresponding to a cross-sectional portion of a gas flow path forming member taken along IVa-IVa of FIG. 5A) of the premixing device illustrated in FIG. 1 to FIG. 3. FIG. 4B is a cross-sectional view taken along IVb-IVb of FIG. 4A. FIG. 4C is a front cross-sectional view illustrating a configuration in the case where a flapper part in a closed state illustrated in FIG. 4A changes to an open state.

FIG. 5A is a plan view of the gas flow path forming member of the premixing device illustrated in FIG. 1 to FIG. 4C. FIG. 5B is an enlarged view of a portion Vb of FIG. 5A. FIG. 5C is a partial cross-sectional plan view of FIG. 5B. FIG. 5D is a partial cross-sectional plan view of a configuration illustrated in FIG. 5C in which a baffle is omitted.

FIG. 6 is a cross-sectional view taken along VI-VI of FIG. 5A.

FIG. 7 is a front cross-sectional view (corresponding to a cross-sectional portion of the gas flow path forming member taken along VII-VII of FIG. 5A) of the premixing device illustrated in FIG. 1 to FIG. 3.

FIG. 8A is an explanatory diagram of effects of the baffle of the embodiment illustrated in FIG. 1 to FIG. 7. FIG. 8B is an explanatory diagram of effects of a comparative example.

FIG. 9A and FIG. 9B illustrate another example of the disclosure. FIG. 9A is a partial cross-sectional plan view of the gas flow path forming member. FIG. 9B is a cross-sectional view taken along IXb-IXb of FIG. 9A.

FIG. 10A and FIG. 10B illustrate another example of the disclosure. FIG. 10A is a plan view of the gas flow path forming member. FIG. 10B is a cross-sectional view taken along X-X of FIG. 10A.

FIG. 11 is a cross-sectional view illustrating an example of the related art.

### DESCRIPTION OF THE EMBODIMENTS

The disclosure provides a premixing device in which a turndown ratio can be increased by a simple configuration while disadvantages such as increased pressure loss are minimized, and a combustion device including the premixing device.

The disclosure employs the following technical means.

A premixing device provided according to a first aspect of the disclosure includes: a gas flow path forming member, having a gas flow path formed therein through which air supplied from outside flows; a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air; and a pair of divided flow paths, configured by dividing a portion of the gas flow path by the blade, and arranged side by side on both sides of the blade with the blade interposed therebetween in an x direction intersecting the air flow direction. The premixing device further includes: a baffle, located upstream of the fuel gas outlet in the air flow direction on an inner peripheral surface of each of the divided flow paths, and being in the shape of a protruding piece or step part protruding inward of each of the divided flow paths. The baffle is provided in at least a portion of an inner region on the blade side of each of the divided flow paths, and is configured to increase a flow velocity of air flowing through an outer region opposite the inner region to be higher than a flow velocity of air passing through the inner region.

According to such a configuration, the following may be achieved.

First, due to effects of the baffle, the air passing through the outer region of each divided flow path and flowing through a region far from the fuel gas outlet has an increased flow velocity. Hence, it is possible to prevent the air that branches and flows through the pair of divided flow paths from joining together at a position in the vicinity facing the fuel gas outlet; in other words, it is possible to suppress a phenomenon in which an outflow of fuel gas from the fuel gas outlet to the gas flow path is hindered. As a result, according to the disclosure, while the negative pressure due to the air flow that acts on the fuel gas outlet is reduced compared to the related art, based on the above effects, it is overall possible to increase the amount of fuel gas flowing out from the fuel gas outlet to the gas flow path, as compared to the related art. For this reason, according to the disclosure, even if the air flow rate in the gas flow path is reduced and the flow velocity of the air is low, by allowing an appropriate amount of fuel gas corresponding to the air flow rate to flow out to the gas flow path, it is possible to prevent the mixed gas from having an inappropriate fuel lean mixture ratio, and to increase a turndown ratio.

On the other hand, in the disclosure, since the baffle is provided on the inner peripheral surface of each divided flow path, the opening area (flow path area) of each divided flow path is reduced accordingly compared to a case without this configuration. However, since the baffle is in the shape of a protruding piece or step part protruding inward from the inner peripheral surface of each divided flow path, and does not reduce an inner diameter of a long dimension region of each divided flow path, it is also possible to suppress an increase in flow path resistance of each divided flow path. It is sufficient that the baffle is provided in the inner region on the blade side of each divided flow path. Since there is no need to provide the baffle over the entire circumference of the inner peripheral surface of each divided flow path, it is possible to further suppress an increase in flow path resistance of each divided flow path (gas flow path). Accordingly, the pressure loss with respect to air flows can be reduced.

In the disclosure, preferably, the baffle is provided so as to avoid at least a portion of the outer region of each of the divided flow paths.

According to such a configuration, it is possible to further prevent an increase in flow path resistance of each divided flow path (gas flow path) and to further increase the flow velocity of the air flowing through the outer region of each divided flow path. That is, unlike the above configuration, for example, if the baffle is provided in the entire outer region in addition to the inner region of each divided flow path, the opening area (flow path area) of each divided flow path is significantly reduced, which is disadvantageous due to increased flow path resistance. The baffle provided in the outer region is hardly effective in increasing the flow velocity of the air flowing through the outer region of each divided flow path, and is rather disadvantageous. In contrast, according to the above configuration, such disadvantages can be appropriately avoided.

In the disclosure, preferably, the baffle has an air receiving surface facing upstream in the air flow direction. The premixing device is configured so that air advancing toward the air receiving surface along the inner peripheral surface of each of the divided flow paths from a position upstream in the air flow direction collides with the air receiving surface, making it possible to generate a vortex of the air.

According to such a configuration, a vortex of air can be generated in a region upstream of the air receiving surface of the baffle in the air flow direction. The vortex itself does not flow at a high speed downstream in the air flow direction through each divided flow path. Accordingly, the flow velocity of the air flowing through the inner region of each divided flow path can be effectively decreased. Hence, a phenomenon in which air that branches and flows through the pair of divided flow paths joins together at the position in the vicinity facing the fuel gas outlet can be relatively effectively reduced.

In the disclosure, preferably, in the gas flow path as viewed in the air flow direction, the inner peripheral surface of each of the divided flow paths includes a pair of first regions adjacent to the blade and facing each other while being spaced apart in a y direction intersecting the x direction. As the baffle, a baffle is provided in at least one of the pair of first regions, a tip edge of the baffle being inclined so as to be located closer to a center of each of the divided flow paths in the y direction as approaching the blade in the x direction.

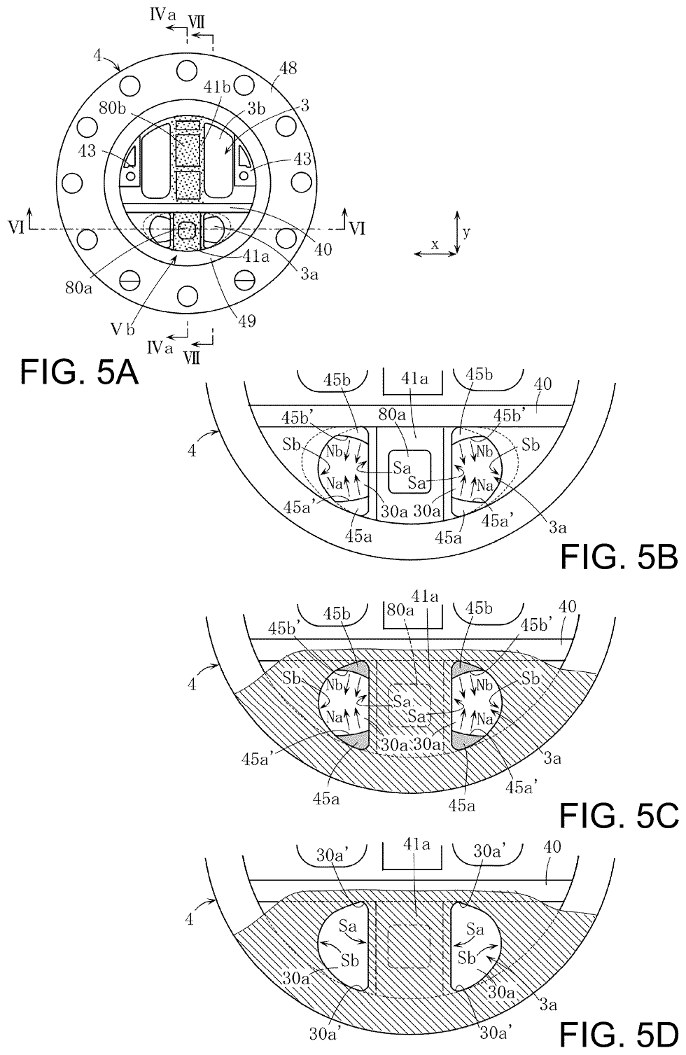

According to such a configuration, it is possible to cause the air flowing through the inner region of each divided flow path to flow toward the outer region by utilizing the baffle whose tip edge is inclined (see also the description with reference to FIG. 5A to FIG. 5D below). Accordingly, the phenomenon in which air that branches and flows through the pair of divided flow paths joins together at the position in the vicinity facing the fuel gas outlet can be relatively thoroughly reduced.

A premixing device provided according to a second aspect of the disclosure includes: a gas flow path forming member, having a gas flow path formed therein through which air supplied from outside flows; a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air; and a pair of divided flow paths, configured by dividing a portion of the gas flow path by the blade, and arranged side by side on both sides of the blade with the blade interposed therebetween in an x direction intersecting the air flow direction. As the fuel gas outlet, a pair of fuel gas outlets are provided to open on both side surfaces of the region near the one end of the blade and respectively facing downstream regions of the pair of divided flow paths in the air flow direction.

According to such a configuration, the following may be achieved.

That is, at a stage before the air that has branched and flowed through the pair of divided flow paths advances downstream of the blade in the air flow direction and joins each other, a negative pressure due to a flow of the air is able to act on each of a pair of fuel gas outlets. Accordingly, even if the air flow rate in the gas flow path is reduced and the flow velocity of the air is low, by allowing an appropriate amount of fuel gas corresponding to the air flow rate to flow out to the gas flow path, it is possible to prevent the mixed gas from having an inappropriate fuel lean mixture ratio, and to increase a turndown ratio. On the other hand, since there is no need to reduce the opening area (flow path area) of each divided flow path, the pressure loss with respect to air flows can be reduced.

In the disclosure, it is also possible to combine a characteristic configuration of the premixing device provided according to the first aspect of the disclosure with a characteristic configuration of the premixing device provided according to the second aspect of the disclosure.

According to such a configuration, the problems of the disclosure may be reliably effectively solved.

In the disclosure, preferably, as the fuel gas outlet, a pair of fuel gas outlets are provided to open on both side surfaces of the region near the one end of the blade and respectively facing downstream regions of the pair of divided flow paths in the air flow direction.

According to such a configuration, at a stage before the air that has branched and flowed through the pair of divided flow paths advances downstream of the blade in the air flow direction and joins each other, a negative pressure due to a flow of the air is able to act on each of a pair of fuel gas outlets. Accordingly, even when the air supplied to the gas flow path has a low flow rate, it is possible that an appropriate amount of fuel gas corresponding thereto flows out to the gas flow path.

In the disclosure, preferably, the gas flow path and the fuel gas outlet are respectively regarded as a first gas flow path and a first fuel gas outlet. The premixing device further includes: a second gas flow path, provided within the gas flow path forming member in a state separated from the first gas flow path by a partition wall; an air inlet section, provided in the gas flow path forming member to allow the air supplied from the outside to branch and advance through each of the first gas flow path and the second gas flow path; a second fuel gas outlet, enabling outflow of a fuel gas to the second gas flow path by utilizing a negative pressure generated by a flow of the air in the second gas flow path; and a flapper capable of, in response to a total air flow rate of the first gas flow path and the second gas flow path being less than a predetermined value, closing the second gas flow path so that the air flows only through the first gas flow path out of the first gas flow path and the second gas flow path.

According to such a configuration, the following may be achieved.

That is, if the air flow rate in the gas flow path is equal to or larger than the predetermined value, the flapper changes to an open state, and a mode (first mode) can be set in which air flows through both the first gas flow path and the second gas flow path. In the first mode, it is possible to cause the fuel gas to flow out from both the first gas flow path and the second gas flow path, and to appropriately mix an appropriate amount of fuel gas corresponding to the flow rate of the air with the air. On the other hand, unlike the above, if the air flow rate in the gas flow path is less than the predetermined value, the flapper changes to a closed state, and a mode (second mode) can be set in which no air flows through the second gas flow path. In the second mode, it is possible to cause the fuel gas to flow out only from the first fuel gas outlet with respect to the air flowing through the first gas flow path and to reduce the amount of fuel gas flowing out. In the disclosure, during setting of the second mode, in the case where the air flow rate in the first gas flow path is significantly reduced, due to the aforementioned effect (suppression of the joining of air at the position in the vicinity facing the first fuel gas outlet) of the blade, the outflow of fuel gas can be accelerated. Accordingly, the above configuration is relatively preferable in terms of increasing the turndown ratio.

A combustion device provided according to a third aspect of the disclosure includes: a premixing device, generating a mixed gas in which air and a fuel gas are mixed; and a burner, receiving supply of the mixed gas from the premixing device and burning the fuel gas. The premixing device provided according to the first aspect of the disclosure is used as the premixing device.

According to such a configuration, the same effects as those described with respect to the premixing device provided according to the first aspect of the disclosure can be achieved.

Hereinafter, embodiments of the disclosure will be specifically described with reference to the drawings.

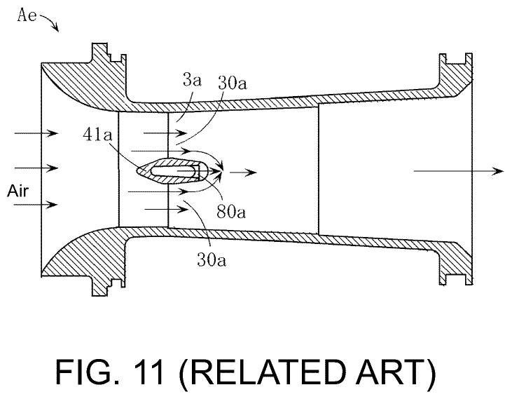

For ease of understanding, elements that are the same as or similar to those in the related art illustrated in FIG. 11 are assigned the same reference numerals as those in FIG. 11.

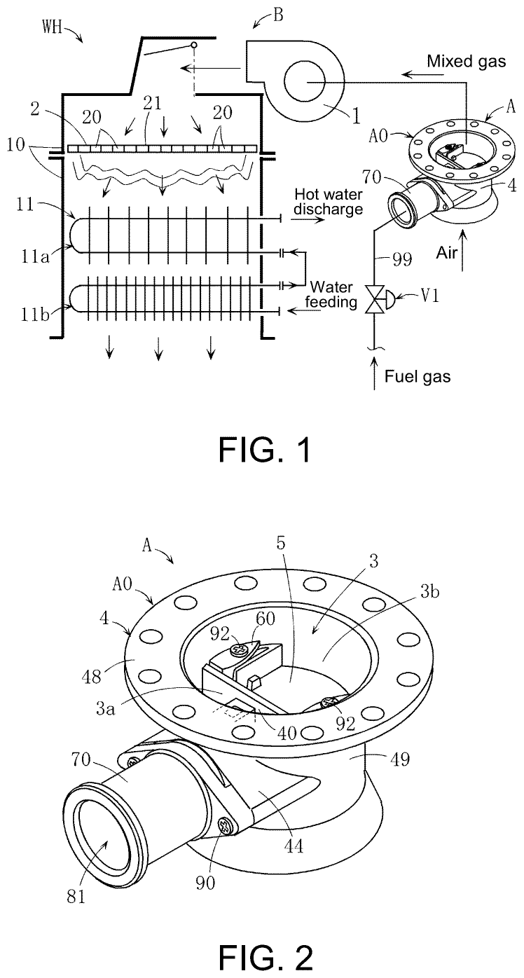

FIG. 1 illustrates a hot water apparatus WH. The hot water apparatus WH is a hot water supply apparatus, and includes a premixing device A, a combustion device B, and a heat exchanger 11. The combustion device B is configured by combining the premixing device A with a fan 1 and a burner 2. The fan 1 has a variable speed (variable air delivery volume).

The premixing device A will be described later in detail. A mixed gas (combustible mixed gas) of air and a fuel gas is generated using the premixing device A, and this mixed gas is supplied to the burner 2 via the fan 1. The burner 2 includes a porous plate 21 having a plurality of ventilation holes 20 (burner ports), and is arranged inside a case 10. An ignition plug, a flame detection sensor, and the like, which are not illustrated, are attached to and provided in the burner 2. The mixed gas passes through the plurality of ventilation holes 20 and is burned below the porous plate 21. A combustion gas generated by the burner 2 is heat-recovered by the heat exchanger 11. The heat exchanger 11 includes, for example, a primary heat exchanger 11a for sensible heat recovery and a secondary heat exchanger 11b for latent heat recovery. The combustion gas acts on the primary heat exchanger 11a and the secondary heat exchanger 11b in sequence, and the hot and cold water passing through inside of the primary heat exchanger 11a and the secondary heat exchanger 11b is heated. The hot water generated by this hot and cold water heating is supplied to a desired hot water supply destination.

As illustrated in FIG. 2 to FIG. 7, the premixing device A includes a device main body A0 and a flapper 5 assembled to the device main body A0.

The device main body A0 includes a gas flow path forming member 4. The gas flow path forming member 4 includes: a tubular part 49, in which a first gas flow path 3a and a second gas flow path 3b described later are formed; a flange 48, connected to an upper end of the tubular part 49; and a pedestal part 44 of a step shape, protruding from an outer surface of the tubular part 49. A pipe body joint part 70 for receiving fuel gas and a fuel gas control plate 71 (described later) are attached to the pedestal part 44 via screw members 90 and 91 such as screws.

As illustrated in FIG. 1, the premixing device A has the pipe body joint part 70 connected to a gas pipe 99, and receives supply of a fuel gas from a fuel gas supply source (not illustrated) via an equalizing valve (zero governor) V1. On the other hand, the premixing device A is directly or indirectly connected to an intake side of the fan 1 by utilizing the flange 48. When the fan 1 is driven, outside air flows into the gas flow path forming member 4 (tubular part 49). Due to effects of a negative pressure caused by this air flow, the fuel gas flows out from a first fuel gas outlet 80a and a second fuel gas outlet 80b described later, and a mixed gas of this fuel gas and the air is generated. This mixed gas is supplied to the burner 2 via the fan 1.

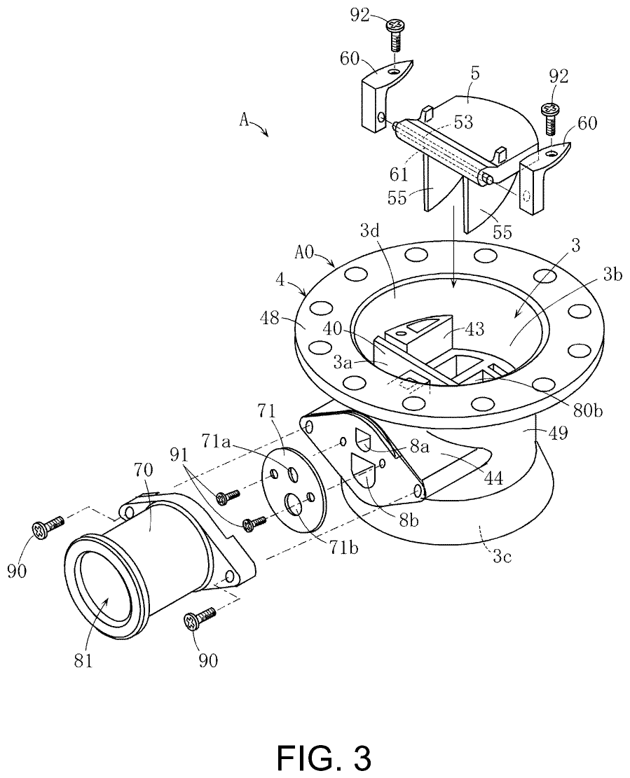

As clearly illustrated in FIG. 2, FIG. 3, and FIG. 7, inside the tubular part 49 of the gas flow path forming member 4, a partition wall 40 is provided to be erected in an up-down height direction (air flow direction in the present embodiment) and to extend in an x direction intersecting the air flow direction. Accordingly, the first gas flow path 3a and the second gas flow path 3b are formed side by side in a horizontal direction with the partition wall 40 interposed therebetween in the tubular part 49.

Out of the first gas flow path 3a and the second gas flow path 3b, the first gas flow path 3a corresponds to an example of a “gas flow path” in the claims.

The partition wall 40 is arranged offset from the center of the tubular part 49 in a y direction (direction intersecting the x direction and the air flow direction). The first gas flow path 3a has smaller flow path area than the second gas flow path 3b. However, the first gas flow path 3a and the second gas flow path 3b may also have the same flow path area.

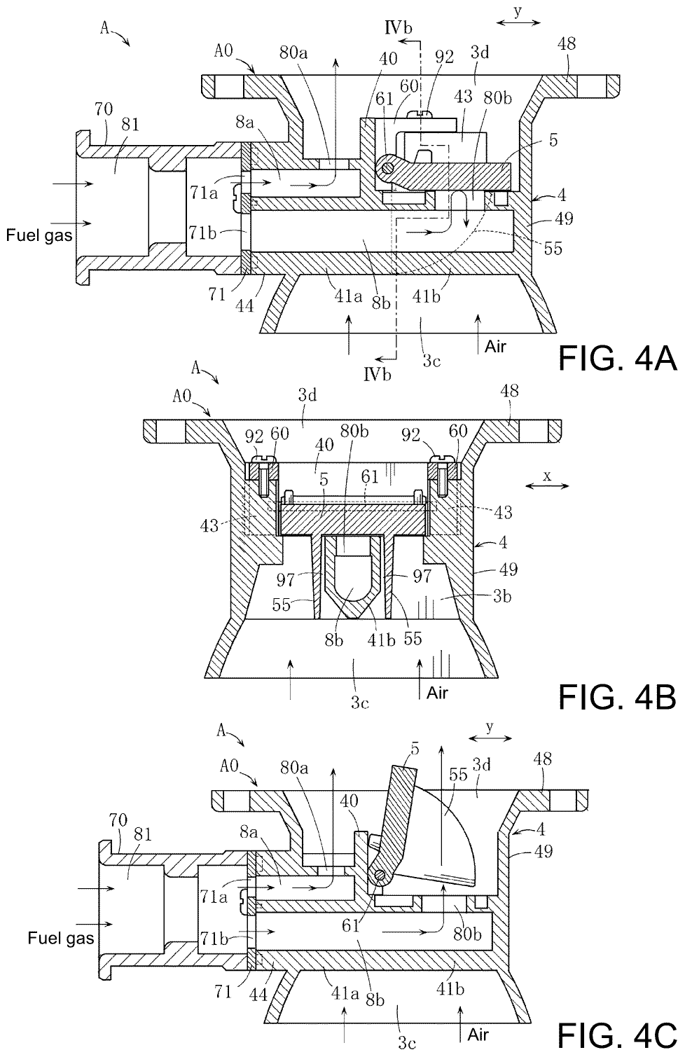

As clearly illustrated in FIG. 4A to FIG. 6, the first gas flow path 3a and the second gas flow path 3b are provided with a first blade 41a and a second blade 41b (dotted portions in FIG. 5A). A first fuel gas outlet 80a and a second fuel gas outlet 80b are further provided in the shape of upward openings on an upper surface of the first blade 41a and the second blade 41b.

Here, out of the first blade 41a and the second blade 41b, the first blade 41a corresponds to an example of a “blade” in the claims.

Out of the first fuel gas outlet 80a and the second fuel gas outlet 80b, the first fuel gas outlet 80a corresponds to an example of a “fuel gas outlet” in the claims.

The first blade 41a and the second blade 41b extend in the y direction so as to horizontally cross the first gas flow path 3a and the second gas flow path 3b, respectively. One end of each of the first blade 41a and the second blade 41b is connected a peripheral wall inner surface (inner surface of peripheral wall of tubular part 49) of the gas flow path 3, and the other ends of the first blade 41a and the second blade 41b are connected to each other with the partition wall 40 interposed therebetween.

In FIG. 4A and FIG. 4C, the pipe body joint part 70 has therein a fuel gas receiving part 81 that receives supply of a fuel gas from the outside. The fuel gas supplied to the fuel gas receiving part 81 passes through openings 71a and 71b of the fuel gas control plate 71, as well as through a first fuel gas flow path 8a and a second fuel gas flow path 8b, and is guided to the first fuel gas outlet 80a and the second fuel gas outlet 80b.

As described above, the fuel gas control plate 71 is attached to the pedestal part 44, and includes the two openings 71a and 71b facing tip openings of the first fuel gas flow path 8a and the second fuel gas flow path 8b. Depending on the opening area of the openings 71a and 71b, the amount of fuel gas flowing from the fuel gas receiving part 81 into the first fuel gas flow path 8a and the second fuel gas flow path 8b can be controlled.

In a lower part and an upper part inside the tubular part 49, an air inlet section 3c and an air outlet section 3d are formed communicating with the first gas flow path 3a and the second gas flow path 3b. When the fan 1 is driven, the outside air may flow into the air inlet section 3c and then branch and flow into the first gas flow path 3a and the second gas flow path 3b. As described above, due to the effects of a negative pressure caused by the air flow in the first gas flow path 3a and the second gas flow path 3b, the fuel gas flows out from the first fuel gas outlet 80a and the second fuel gas outlet 80b, and a mixed gas of the air and the fuel gas is generated. This mixed gas flows out of the tubular part 49 from the air outlet section 3d.

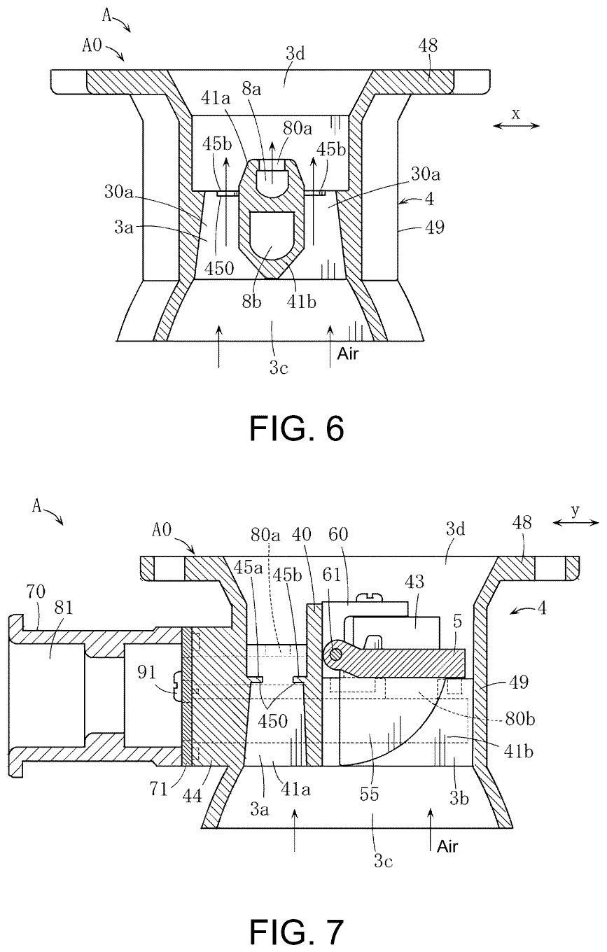

As clearly illustrated in FIG. 6, the first blade 41a divides a portion of the first gas flow path 3a into a pair of divided flow paths 30a. In the x direction, the pair of divided flow paths 30a are arranged side by side on both sides of the first blade 41a with the first blade 41a interposed therebetween.

The pair of divided flow paths 30a corresponds to an example of a “pair of divided flow paths” in the claims. In the present embodiment, baffles 45a and 45b are provided as a configuration attached to the pair of divided flow paths 30a, and this configuration has a major feature to be described later in detail.

A portion of the second gas flow path 3b is divided into a pair of divided flow paths 30b with the second blade 41b interposed therebetween. The pair of divided flow paths 30b does not correspond to the “pair of divided flow paths” in the claims. In the present embodiment, the configuration using the baffles 45a and 45b is applied only to the first gas flow path 3a side out of the first gas flow path 3a and the second gas flow path 3b.

The flapper 5 operates in accordance with a total air flow rate of the first gas flow path 3a and the second gas flow path 3b so that, if the total air flow rate is small, the flapper 5 has a smaller opening degree than if the total air flow rate is large. The flapper 5 opens and closes to control the second gas flow path 3b and the second fuel gas outlet 80b. More specifically, a shaft body 61 serving as a rotation fulcrum is inserted through a rear part of the flapper 5, and the shaft body 61 is supported by a pair of left and right support members 60. The pair of support members 60 are attached by using a screw member 92 or the like to a step part 43 separately provided within the second gas flow path 3b. Accordingly, the flapper 5 is rotatable above the second blade 41b about the shaft body 61 in accordance with the total air flow rate. When the total air flow rate is less than a predetermined value, as illustrated in FIG. 4A, the flapper 5 changes to the closed state due to its own weight, and the second gas flow path 3b and the second fuel gas outlet 80b are blocked. In contrast, when the total air flow rate is equal to or larger than the predetermined value, for example, as illustrated in FIG. 4C, the flapper 5 is pushed up by an air flow, and the second gas flow path 3b and the second fuel gas outlet 80b change to the open state.

In the present embodiment, the flapper 5 includes a pair of fins 55 that can be arranged on both sides of the second blade 41b in a close manner to the second blade 41b with a gap 97 therebetween (see FIG. 4B). However, the disclosure is not limited thereto.

As clearly illustrated in FIG. 5A to FIG. 7, for example, two baffles 45a and 45b (illustrated in gray in FIG. 5C) are provided on an inner peripheral surface of each divided flow path 30a of the first gas flow path 3a.

In each divided flow paths 30a, the baffles 45a and 45b are portions for, relative to a flow velocity of air flowing through an inner region Sa on the first blade 41a side, increasing a flow velocity of air flowing through an outer region Sb opposite the inner region Sa (specific functions and effects of the baffles 45a and 45b will be described later in detail).

The baffles 45a and 45b are located upstream of the first fuel gas outlet 80a in the air flow direction on the inner peripheral surface of each divided flow path 30a, and are in the shape of a protruding piece or step part protruding inward of each divided flow path 30a. As illustrated in FIG. 6 and FIG. 7, the baffles 45a and 45b have an air receiving surface 450 facing downward (upstream in the air flow direction). The air receiving surface 450 protrudes in a substantially horizontal direction from a general portion of the inner peripheral surface of each divided flow path 30a.

In a plan view or a plan cross-sectional view (as viewed in the air flow direction) illustrated in FIG. 5B and FIG. 5C, the baffles 45a and 45b are arranged facing each other while being spaced apart in the y direction. At least a portion of the baffles 45a and 45b is located in the inner region Sa of each divided flow path 30a. The baffles 45a and 45b are arranged so as to avoid a near central portion of the first blade 41a in a longitudinal direction (y direction). More specifically, the inner peripheral surface of each divided flow path 30a includes a pair of first regions 30a′ adjacent to the first blade 41a and facing each other while being spaced apart in the y direction. In contrast, the baffles 45a and 45b are provided in the pair of first regions 30a′, respectively. A tip edge 45a′ of the baffle 45a and a tip edge 45b′ of the baffle 45b are inclined so as to be located closer to the center of each divided flow path 30a in the y direction as approaching the first blade 41a in the x direction.

The baffles 45a and 45b are arranged to avoid at least a portion of the outer region Sb of each divided flow path 30a (the outer region Sb includes portions where the baffles 45a and 45b are not provided).

Next, effects of the premixing device A and the combustion device B including the premixing device A are described.

At the start of driving combustion of the burner 2 of the combustion device B or during general driving combustion thereafter, by changing a driving speed of the fan 1 and changing a flow rate of the mixed gas supplied from the premixing device A to the burner 2, control on the driving combustion power of the burner 2 is performed.

Here, if the driving speed of the fan 1 is a low speed and the air flow rate within the gas flow path forming member 4 is small, as illustrated in FIG. 4A, the flapper 5 changes to the closed state, the air does not flow through the second flow path 3b and flows only through the first gas flow path 3a. In this case, when the air flow rate in the first gas flow path 3a is significantly reduced, a negative pressure due to a flow of the air does not act strongly on the first fuel gas outlet 80a. On the other hand, if a phenomenon occurs in which a large proportion of the air passing through each of the pair of divided flow paths 30a of the first gas flow path 3a joins together at the position in the vicinity facing the first fuel gas outlet 80a, as in the related art described with reference to FIG. 11, the amount of fuel gas flowing out from the first fuel gas outlet 80a is further reduced. In contrast, according to the present embodiment, it is possible to appropriately suppress such problems, as will be described below.

That is, due to the effects of the baffles 45a and 45b, the flow velocity of the air passing through the outer region Sb of each divided flow path 30a becomes higher than the flow velocity of the air passing through the inner region Sa.

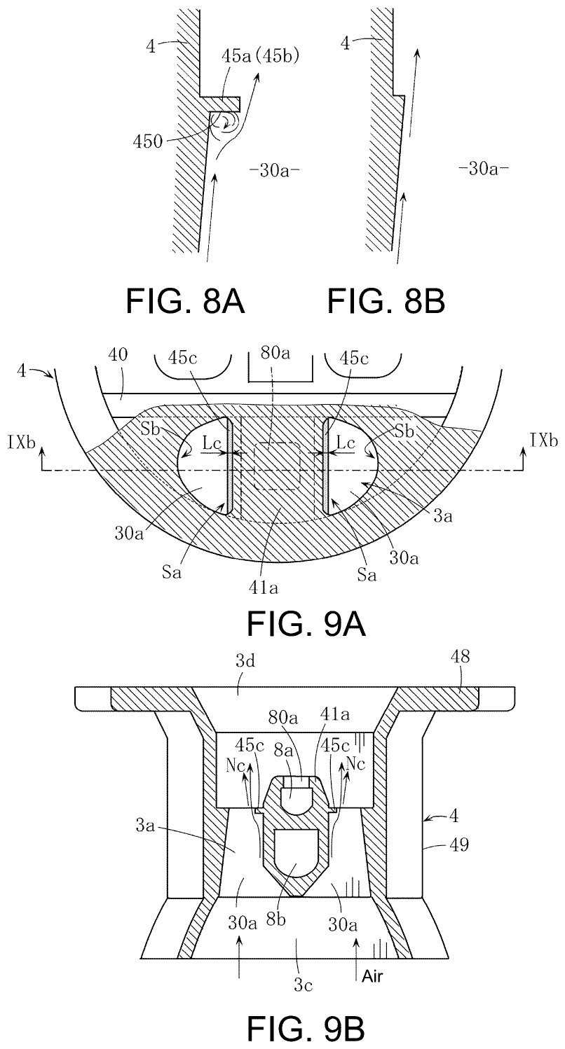

To explain this point, in a comparative example of FIG. 8B, neither of the baffles 45a and 45b is provided on the inner peripheral surface of the divided flow path 30a. In this case, the air simply flows along the inner peripheral surface of the divided flow path 30a. In contrast, in the present embodiment, as illustrated in FIG. 8A, a portion of the air flowing along the inner peripheral surface of the divided flow path 30a collides with the baffle 45a (45b), a vortex occurs in an upstream region of the baffle 45a (45b) in the air flow direction. The baffle 45a (45b) has the air receiving surface 450 facing upstream in the air flow direction and is thus advantageous in reliably causing the vortex to occur.

When the aforementioned vortex occurs, the following effects may be achieved.

First, the vortex itself does not keep advancing downstream. A flow velocity of the air flowing near the vortex is affected by the vortex and is likely to decrease. On the other hand, the baffles 45a and 45b are provided in the inner region Sa of each divided flow path 30a, and the vortex occurs in this region. Accordingly, the flow velocity of the air passing through the inner region Sa decreases, and the flow velocity of the air passing through the outer region Sb relatively increases.

Second, as illustrated in FIG. 8A, most of the air advancing toward the baffle 45a (45b) from upstream thereof advances so as to spread out to a lateral side of the vortex, and varies in its advancement direction so as to advance closer to the inside of the divided flow path 30a than in its original advancement direction. On the other hand, the tip edge 45a′ of the baffle 45a and the tip edge 45b′ of the baffle 45b are in a predetermined inclined state as described with reference to FIG. 5B and FIG. 5C. Hence, the air passing through the vicinity of the tip edge 45a′ of the baffle 45a and the tip edge 45b′ of the baffle 45b flows in a direction opposite the first blade 41a, as indicated by arrows Na and Nb. Hence, the air flow rate in the outer region Sb of each divided flow path 30a increases, and the flow velocity of the air in the outer region Sb increases.

Unlike the present embodiment, if a portion of the baffles 45a and 45b is extended to the outer region Sb, there is a risk that the portion of the baffles 45a and 45b may act to cause the air advancing through the outer region Sb to flow toward the inner region Sa. In the present embodiment, it is possible to appropriately avoid such a risk.

As described above, when the flow velocity of the air in the outer region Sb is increased, the air that branches and flows through the pair of divided flow paths 30a is prevented from joining together at the position in the vicinity facing the first fuel gas outlet 80a. The joining of the air prevents the fuel gas from flowing out from the first fuel gas outlet 80a to the first gas flow path 3a, and is appropriately suppressed. As a result, according to the present embodiment, compared to a case where neither of the baffles 45a and 45b is provided, the negative pressure of the air flow acting on the first fuel gas outlet 80a may be slightly reduced. However, overall, the amount of fuel gas flowing out from the first fuel gas outlet 80a can be increased. Accordingly, even if the air flow rate is small, an appropriate amount of fuel gas for the air flow rate is mixed with the air, a mixed gas having an appropriate mixture ratio can be obtained, and a turndown ratio can be increased.

On the other hand, in the present embodiment, while the baffles 45a and 45b are provided on the inner peripheral surface of each divided flow path 30a, the baffles 45a and 45b are in the shape of a protruding piece or step part, and do not reduce an inner diameter of a long dimension region of each divided flow path 30a. The baffles 45a and 45b are not provided long over the entire circumference of the inner peripheral surface, and are partially provided. For example, the baffles 45a and 45b are not provided on the inner peripheral surface of the outer region Sb. Hence, flow path resistance of each divided flow path 30a does not significantly increase. Accordingly, pressure loss of the air flow can be reduced.

Unlike the above, when the driving speed of the fan 1 is a high speed and the air flow rate within the gas flow path forming member 4 is larger than a predetermined value, as illustrated in FIG. 4C, the flapper 5 changes to the open state, and the air also flows through the second gas flow path 3b. Here, the second gas flow path 3b is not provided with any means corresponding to the baffles 45a and 45b. However, in the case where the air flows through the second gas flow path 3b, namely in the case where the air flow rate is large, since a strong negative pressure due to the air flow acts on the second fuel gas outlet 80b, there is no or almost no risk of a shortage in the amount of fuel gas flowing out. Accordingly, while the second gas flow path 3b is not provided with any means corresponding to the baffles 45a and 45b, no particular problems are caused.

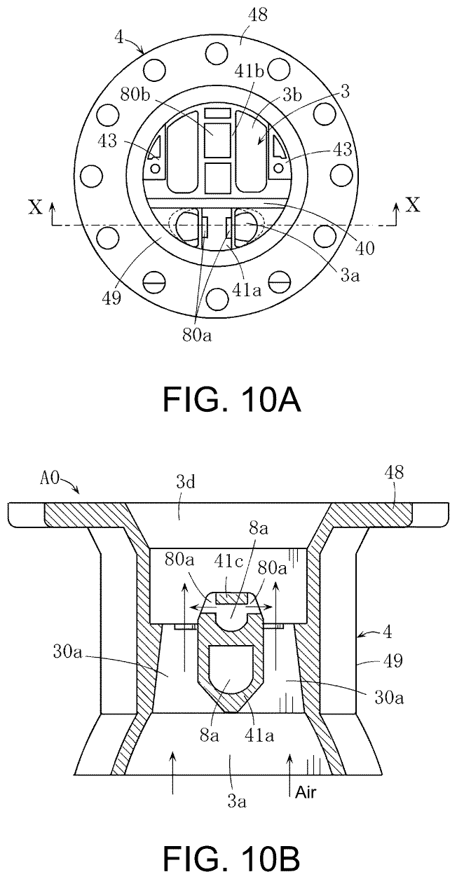

FIG. 9A to FIG. 9B and FIG. 10A to FIG. 10B illustrate another embodiment of the disclosure. In these drawings, elements that are the same as or similar to those of the above embodiment are assigned the same reference numerals as those of the above embodiment, and repeated descriptions are omitted.

In the embodiment illustrated in FIG. 9A to FIG. 9B, a pair of baffles 45c (illustrated in gray in FIG. 9A) are protruding from both side surfaces of the first blade 41a. The both side surfaces correspond to a portion of the inner peripheral surface of the first gas flow path 3a.

According to the present embodiment, the air that has advanced toward the baffle 45c changes direction in the x direction into a direction away from the first blade 41a, as indicated by arrow Nc. Hence, the air passing through the pair of divided flow paths 30a is prevented from joining together at the position in the vicinity facing the first fuel gas outlet 80a. Accordingly, the fuel gas flows out from the first fuel gas outlet 80a in an appropriate manner. If a width Lc of the baffle 45c is excessively large, a place where the air flows through is excessively far from the first fuel gas outlet 80a, and a negative pressure may not effectively act on the first fuel gas outlet 80a. By setting the width Lc to an appropriate value, it is possible to appropriately avoid such a situation.

In the embodiment illustrated in FIG. 10A to FIG. 10B, as a first fuel gas outlet, a pair of first fuel gas outlets 80a are provided in the shape of lateral openings on both side surfaces of a region (region near one end downstream in the air flow direction) near an upper end of the first blade 41a. The pair of first fuel gas outlets 80a face a downstream region of each of the pair of divided flow paths 30a in the air flow direction, respectively. A gas flow path blocking wall 41c is provided on an upper side between the pair of first fuel gas outlets 80a. A gas in the first fuel gas flow path 8a is prevented from flowing out from any place other than the pair of first fuel gas outlets 80a in the shape of lateral openings.

According to the present embodiment, at a stage before the air that has branched and flowed through the pair of divided flow paths 30a advances downstream of the first blade 41a in the air flow direction and joins each other, a negative pressure due to a flow of the air is able to act on each of the pair of first fuel gas outlets 80a. Accordingly, when the air flow rate in the first gas flow path 3a is small, it can be reliably prevented that the amount of the fuel gas flowing out becomes excessively small.

The disclosure is not limited to the content of the above embodiments. The specific configuration of each part of the premixing device and the combustion device according to the disclosure may be modified in various ways within the intended scope of the disclosure.

The gas flow path (first gas flow path in the above embodiments) as referred to in the disclosure is preferably of a Venturi shape. However, the disclosure is not limited thereto. The gas flow path forming member does not necessarily have to include a first gas flow path and a second gas flow path, and may include, for example, only one gas flow path.

In the case where there are a first gas flow path and a second gas flow path, and a flapper is provided in the second gas flow path, for example, a type of flapper that is opened and closed by a motor can be used as the flapper.

The fuel gas is, for example, natural gas or liquefied petroleum (LP) gas. However, it does not matter which specific type of fuel gas is used. The combustion device according to the disclosure is not limited to the use in a hot water apparatus, and may also be used as a combustion device for other applications such as room heating or incineration. The combustion device is not limited to a type that causes the combustion gas to advance downward, and may also be of a type that causes the combustion gas to, for example, advance upward.

1. A premixing device comprising:
a gas flow path forming member, having a gas flow path formed therein through which air supplied from outside flows;
a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air;
a pair of divided flow paths, configured by dividing a portion of the gas flow path by the blade, and arranged side by side on both sides of the blade with the blade interposed therebetween in an x direction intersecting the air flow direction; and
a baffle, located upstream of the fuel gas outlet in the air flow direction on an inner peripheral surface of each of the divided flow paths, and being in the shape of a protruding piece or step part protruding inward of each of the divided flow paths, wherein
the baffle is provided in at least a portion of an inner region on the blade side of each of the divided flow paths, and is configured to increase a flow velocity of air flowing through an outer region opposite the inner region to be higher than a flow velocity of air passing through the inner region.

2. The premixing device according to claim 1, wherein
the baffle is provided so as to avoid at least a portion of the outer region of each of the divided flow paths.

3. The premixing device according to claim 1, wherein
the baffle has an air receiving surface facing upstream in the air flow direction; and
the premixing device is configured so that air advancing toward the air receiving surface along the inner peripheral surface of each of the divided flow paths from a position upstream in the air flow direction collides with the air receiving surface, making it possible to generate a vortex of the air.

4. The premixing device according to claim 3, wherein
in the gas flow path as viewed in the air flow direction, the inner peripheral surface of each of the divided flow paths comprises a pair of first regions adjacent to the blade and facing each other while being spaced apart in a y direction intersecting the x direction; and
as the baffle, a baffle is provided in at least one of the pair of first regions, a tip edge of the baffle being inclined so as to be located closer to a center of each of the divided flow paths in the y direction as approaching the blade in the x direction.

5. The premixing device according to claim 1, comprising:
as the fuel gas outlet, a pair of fuel gas outlets provided to open on both side surfaces of the region near the one end of the blade and respectively facing downstream regions of the pair of divided flow paths in the air flow direction.

6. The premixing device according to claim 1, wherein
the gas flow path and the fuel gas outlet are respectively regarded as a first gas flow path and a first fuel gas outlet, and the premixing device further comprises:
a second gas flow path, provided within the gas flow path forming member in a state separated from the first gas flow path by a partition wall;
an air inlet section, provided in the gas flow path forming member to allow the air supplied from the outside to branch and advance through each of the first gas flow path and the second gas flow path;
a second fuel gas outlet, enabling outflow of a fuel gas to the second gas flow path by utilizing a negative pressure generated by a flow of the air in the second gas flow path; and
a flapper capable of, in response to a total air flow rate of the first gas flow path and the second gas flow path being less than a predetermined value, closing the second gas flow path so that the air flows only through the first gas flow path out of the first gas flow path and the second gas flow path.

7. A combustion device comprising:
a premixing device, generating a mixed gas in which air and a fuel gas are mixed; and
a burner, receiving supply of the mixed gas from the premixing device and burning the fuel gas, wherein
the premixing device according to claim 1 is used as the premixing device.

8. A premixing device comprising:
a gas flow path forming member, having a gas flow path formed therein through which air supplied from outside flows;
a blade, arranged midway of the gas flow path and provided with a fuel gas outlet in a region near one end downstream in an air flow direction, the fuel gas outlet allowing a fuel gas to flow out to the gas flow path by utilizing a negative pressure generated due to effects of a flow of the air; and
a pair of divided flow paths, configured by dividing a portion of the gas flow path by the blade, and arranged side by side on both sides of the blade with the blade interposed therebetween in an x direction intersecting the air flow direction, wherein
as the fuel gas outlet, a pair of fuel gas outlets are provided to open on both side surfaces of the region near the one end of the blade and respectively facing downstream regions of the pair of divided flow paths in the air flow direction.

9. A combustion device comprising:
a premixing device, generating a mixed gas in which air and a fuel gas are mixed; and
a burner, receiving supply of the mixed gas from the premixing device and burning the fuel gas, wherein
the premixing device according to claim 8 is used as the premixing device.
